(19) United States
(12) Patent Application Publication
(10) Pub. No.: US 2017/0058920 A1
(43) Pub. Date: Mar. 2, 2017

(54) PNEUMATIC DEVICE

(71) Applicant: BASSO INDUSTRY CORP., Taichung (TW)

(72) Inventors: Liang-Chi HUNG, Taichung (TW); Li-Hsin CHANG, Taichung (TW)

(21) Appl. No.: 15/244,423

(22) Filed: Aug. 23, 2016

(30) Foreign Application Priority Data
Aug. 25, 2015 (TW) 104213748

(51) Int. Cl. F15B 15/14

(52) U.S. Cl. CPC F15B 15/149

(57) ABSTRACT

A pneumatic device includes a cylinder, a piston rod and a valve unit. The cylinder includes an air chamber in which the piston rod is mounted, and a plurality of first backward flow paths. The valve unit is connected to the cylinder, and includes a valve seat assembly, and a valve member. The valve seat assembly includes an intake passage, a plurality of forward flow paths and a plurality of second backward flow paths. The valve member is movable between a first position where fluid communication between the intake passage and each of the second backward flow paths is prevented, and a second position where fluid communication between each of the forward flow paths and the communicating hole is prevented.

### CROSS-REFERENCE TO RELATED APPLICATION

This application claims priority of Taiwanese Patent Application No. 104213748, filed on Aug. 25, 2015.

### FIELD

The disclosure relates to a pneumatic device, and more particularly to a reciprocating pneumatic device.

### BACKGROUND

Referring to FIGS. 1 and 2, a conventional pneumatic device 1 is used in a pneumatic saw, and includes a cylinder 11, a piston rod 12 movably and partially mounted in the cylinder 11 and mounted with a saw blade (not shown), and a valve assembly 13. The cylinder 11 has an air chamber 110, and two first backward flow paths 111 that are in fluid communication with the air chamber 110. The valve assembly 13 is mounted to the cylinder 11, and includes a valve space 130, an intake passage 132 that is in fluid communication with the valve space 130 for guiding inflow of air, a communicating hole 133 that is in fluid communication with the air chamber 110, a forward flow path 134 that is in fluid communication with the intake passage 132, two second backward flow paths 135 that are respectively in fluid communication with the first backward flow paths 111 and that are in fluid communication with the valve space 130, and a valve member 131 that is movably mounted in the valve space 130. The first backward flow paths 111 are in fluid communication with a portion of the air chamber 110 distal from the valve assembly 13. The communicating hole 133 is in fluid communication with another portion of the air chamber 110 proximate to the valve assembly 13.

When the valve member 131 is pneumatically moved to a first position (see FIG. 1) where fluid communication between each of the second backward flow paths 135 and the intake passage 132 is prevented, air flows from the intake passage 132 into the air chamber 110 via the forward flow path 134 and the communicating hole 133 so as to push the piston rod 12 away from the valve assembly 13. When the valve member 131 is pneumatically moved to a second position (see FIG. 2) where fluid communication between the forward flow path 134 and the communicating hole 133 is prevented, air flows from the intake passage 132 into the air chamber 110 via the second backward flow paths 135 and the first backward flow paths 111 so as to push the piston rod 12 toward the valve assembly 13. The piston rod 12 drives reciprocating movement of the saw blade upon reciprocating movement of the valve member 131 between the first and second positions, so as to perform a sawing operation.

However, the flow rate of the air flowing through the forward flow path 134 or the first and second backward flow paths 111, 135 may be insufficient so that the mechanical strength of the sawing operation of the pneumatic saw is inferior.

### SUMMARY

Therefore, an object of the disclosure is to provide a pneumatic device that can alleviate at least one of the drawbacks of the prior art.

According to an aspect of the disclosure, the pneumatic device includes a cylinder, a piston rod and a valve unit. The cylinder includes a cylinder wall that defines an air chamber therein, and a plurality of first backward flow paths that are formed in the cylinder wall. Each of the first backward flow paths extends from a first end of the cylinder wall toward a second end of the cylinder wall that is opposite to the first end, and is in fluid communication with a portion of the air chamber that is adjacent to the second end of the cylinder wall. The piston rod is movably mounted to the cylinder, and is operable to move relative to the cylinder between an impact position and a restoring position. The valve unit is connected to the first end of the cylinder wall of the cylinder, and includes a valve seat assembly that defines a valve space therein, and a valve member that is movably disposed in the valve space. The valve seat assembly includes an intake passage that is for guiding inflow of air, a communicating hole that is in fluid communication with another portion of the air chamber adjacent to the first end of the cylinder wall, a plurality of forward flow paths that are in fluid communication with the intake passage and the valve space, and a plurality of second backward flow paths that are respectively in fluid communication with the first backward flow paths. The valve member is operable to move relative to the valve seat assembly between a first position where fluid communication between the intake passage and each of the second backward flow paths is prevented, and a second position where fluid communication between each of the forward flow paths and the communicating hole is prevented. When the valve member is at the first position, air flows from the intake passage, through the forward flow paths, the valve space and the communicating hole and into the air chamber, so that the piston rod is moved toward the impact position. When the valve member is at the second position, air flows from the intake passage, through the second backward flow paths and the first backward flow paths and into the air chamber, so that the piston rod is moved toward the restoring position.

According to another aspect of the disclosure, the pneumatic device includes a cylinder, a piston rod and a valve unit. The cylinder includes a cylinder wall that defines an air chamber therein, and a plurality of first backward flow paths that are formed in the cylinder wall. Each of the first backward flow paths extends from a first end of the cylinder wall toward a second end of the cylinder wall that is opposite to the first end, and is in fluid communication with a portion of the air chamber that is adjacent to the second end of the cylinder wall. The piston rod is movably mounted to the cylinder, and is operable to move relative to the cylinder between an impact position and a restoring position. The valve unit is connected to the first end of the cylinder wall of the cylinder, and includes a valve seat assembly that defines a valve space therein, and a valve member that is movably disposed in the valve space. The valve seat assembly includes an intake passage that is for guiding inflow of air, a communicating hole that is in fluid communication with another portion of the air chamber adjacent to the first end of the cylinder wall, a forward flow paths that is in fluid communication with the intake passage and the valve space, and a plurality of second backward flow paths that are respectively in fluid communication with the first backward flow paths. The total cross-sectional area of the second backward flow paths is 2 to 6 percent of the cross-sectional area of the valve seat assembly. The valve member is operable to move relative to the valve seat assembly between a first position where fluid communication between the intake passage and each of the second backward flow paths is prevented, and a second position where fluid communication between each of the forward flow paths and the communicating hole is prevented. When the valve member is at the first position, airflows from the intake passage, through the forward flow paths, the valve space and the communicating hole and into the air chamber, so that the piston rod is moved toward the impact position. When the valve member is at the second position, air flows from the intake passage, through the second backward flow paths and the first backward flow paths and into the air chamber, so that the piston rod is moved toward the restoring position.

### BRIEF DESCRIPTION OF THE DRAWINGS

Other features and advantages of the disclosure will become apparent in the following detailed description of the embodiments with reference to the accompanying drawings, of which:

FIG. 1 is a schematic sectional view illustrating a valve member of a conventional pneumatic device at a first position;

FIG. 2 is another schematic sectional view illustrating the valve member of the conventional pneumatic device at a second position;

FIG. 3 is an exploded perspective view illustrating a first embodiment of the pneumatic device according to the disclosure;

FIG. 4 is a perspective view illustrating a main valve seat of the first embodiment;

FIG. 5 is a schematic sectional view illustrating a valve member of the first embodiment at a first position;

FIG. 6 is another schematic sectional view illustrating the valve member of the first embodiment at a second position;

FIG. 7 is a perspective view illustrating a main valve seat of a second embodiment of the pneumatic device according to the disclosure;

FIG. 8 is a perspective view illustrating a main valve seat of a third embodiment of the pneumatic device according to the disclosure; and

FIG. 9 is a perspective view illustrating a main valve seat of a fourth embodiment of the pneumatic device according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

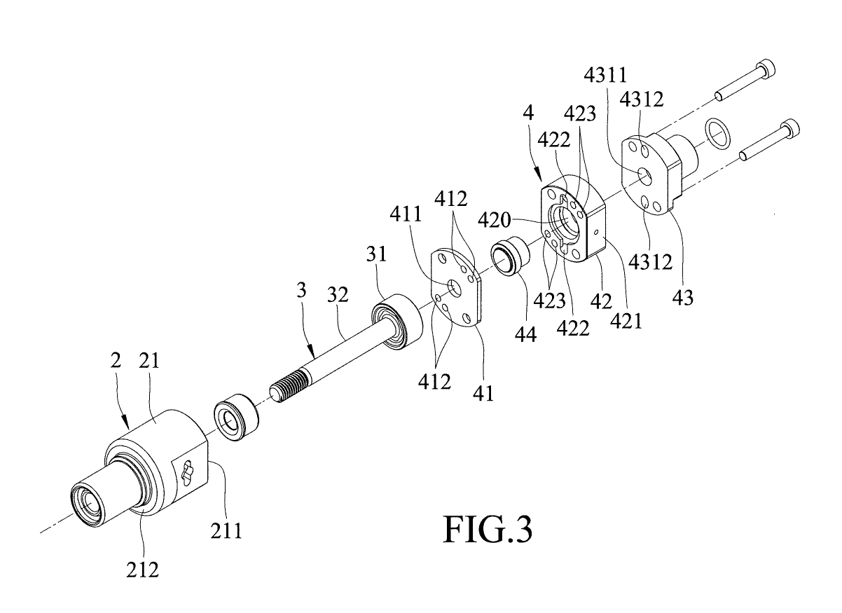

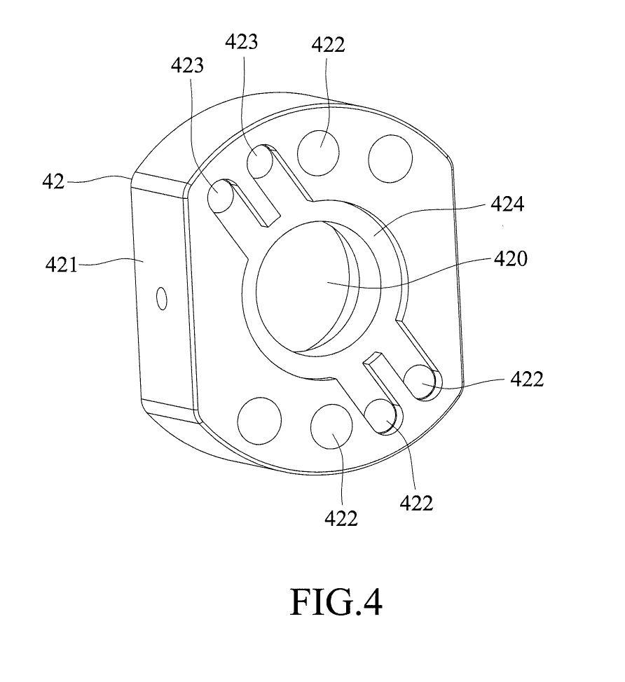

Referring to FIGS. 3 to 6, the first embodiment of the pneumatic device according to the disclosure is for use in a pneumatic saw, and includes a cylinder 2, a piston rod 3 and a valve unit 4.

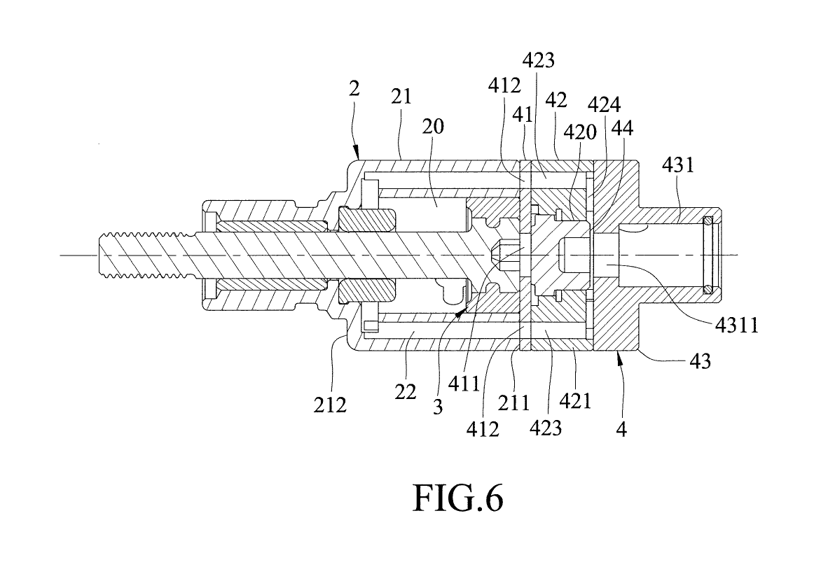

The cylinder 2 includes a cylinder wall 21 that defines an air chamber 20 therein, and four first backward flow paths 22 (only two are visible in FIG. 6) that are formed in the cylinder wall 21. Each of the first backward flow paths 22 extends from a first end 211 of the cylinder wall 21 toward a second end 212 of the cylinder wall 21 that is opposite to the first end 211, and is in fluid communication with a portion of the air chamber 20 that is adjacent to the second end 212 of the cylinder wall 21.

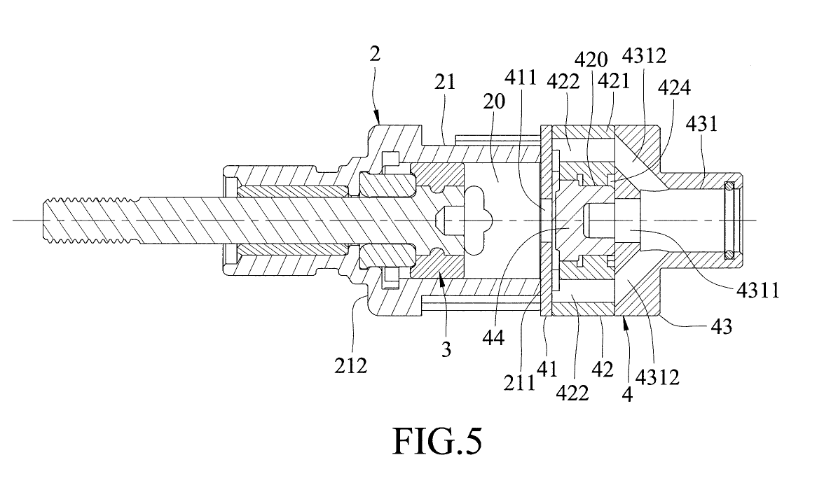

The piston rod 3 has a piston portion 31 movably disposed in the air chamber 20, and a rod portion 32 extending from the piston portion 31 and mounted with a saw blade (not shown). The piston rod 3 is movable relative to the cylinder 2 between an impact position (see FIG. 5) and a restoring position (see FIG. 6).

The valve unit 4 is connected to the first end 211 of the cylinder wall 21 of the cylinder 2, and includes a front valve seat 41, a main valve seat 42, a rear valve seat 43 and a valve member 44. The front valve seat 41, the main valve seat 42 and the rear valve seat 43 cooperatively form a valve seat assembly.

The front valve seat 41 is connected to the first end 211 of the cylinder wall 21, and has a communicating hole 411 that is in fluid communication with another portion of the air chamber 20 that is adjacent to the first end 211 of the cylinder wall 21, and two intermediate hole units that are respectively located at two diametrically-opposite sides of the communicating hole 411. In this embodiment, each of the intermediate hole units includes two intermediate holes 412 that are proximate to each other. The intermediate holes 412 of the intermediate hole units are respectively in fluid communication with the first backward flow paths 22.

The main valve seat 42 is connected to an end of the front valve seat 41 distal from the cylinder 2, and includes a surrounding wall 421 that defines a valve space 420 therein, two forward flow paths 422 that are respectively located at two diametrically-opposite sides of the valve space 420 and that are in fluid communication with the valve space 420, two second backward flow path units that are respectively located at another two diametrically-opposite sides of the valve space 420, and a communicating groove 424 that is formed at an end of the main valve seat 42 distal from the front valve seat 41. In this embodiment, each of the forward flow paths 422 extends from the end of main valve seat 42 distal from the front valve seat 41 and toward the front valve seat 41. Each of the second backward flow path units includes two second backward flow paths 423 that are proximate to each other. Each of the second backward flow paths 423 of the second backward flow path units extends from the end of main valve seat 42 distal from the front valve seat 41 and toward the front valve seat 41, and is in fluid communication with a respective one of the intermediate holes 412 of the front valve seat 41. The communicating groove 424 is in fluid communication with the valve space 420 and the second backward flow paths 423 of the second backward flow path units.

The rear valve seat 43 is connected to the end of the main valve seat 42 distal from the front valve seat 41, and has an intake passage 431 that is for guiding inflow of air, a primary flow path 4311 that is in fluid communication with the intake passage 431, and two secondary flow paths 4312 each of which is in fluid communication with the intake passage 431 and a respective one of the forward flow paths 422.

The valve member 44 is disposed in the valve space 420 in the main valve seat 42, and is movable relative to the main valve seat 42 between a first position (see FIG. 5) where fluid communication between the primary flow path 4311 and the communicating groove 424 is prevented and fluid communication between each of the forward flow paths 422 and the communicating hole 411 is permitted, and a second position (see FIG. 6) where the fluid communication between the primary flow path 4311 and the communicating groove 424 is permitted and the fluid communication between each of the forward flow paths 422 and the communicating hole 411 is prevented.

Referring to FIG. 5, when the valve member 44 is at the first position, air flows through the secondary flow paths 4312, the forward flow paths 422, the valve space 420 and the communicating hole 411 and into the air chamber 20, and is prevented from flowing into the communicating groove 424 so that the piston rod 3 is moved toward the impact position.

Referring to FIG. 6, when the valve member 44 is at the second position, air flows through the primary flow path 4311, the communicating groove 424, the second backward flow paths 423, the intermediate holes 41, the first backward flow paths 22 and into the air chamber 20, and is prevented from flowing into the communicating hole 411, so that the piston rod 3 is moved toward the restoring position.

By virtue of the difference between the air pressures at two opposite sides of the piston portion 31 of the piston rod 3, the piston rod 3 is moved between the impact position and restoring position so as to drive reciprocating movement of the saw blade to perform a sawing operation upon reciprocating movement of the valve member 44 between the first and second positions.

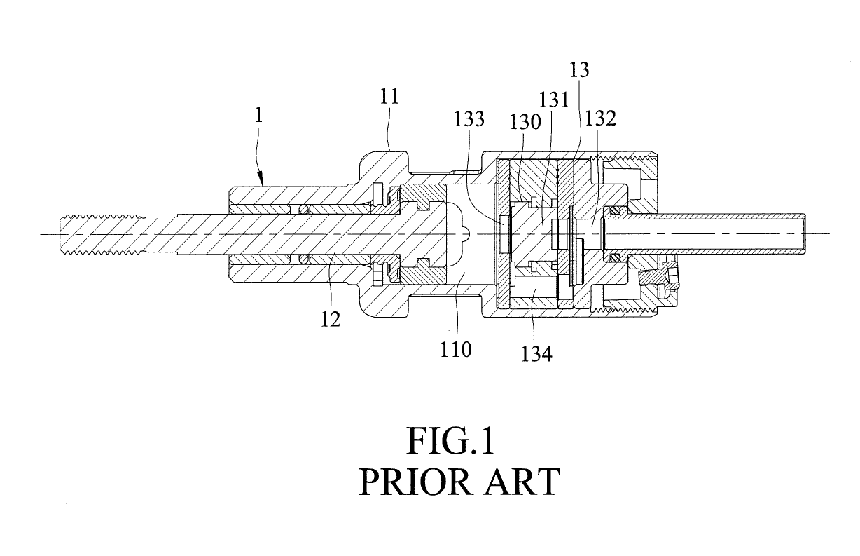

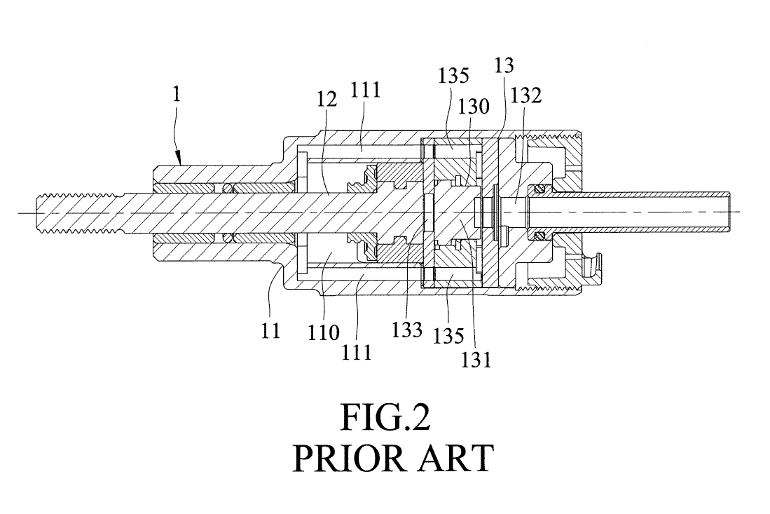

Compared with the a conventional pneumatic device 1 (see FIGS. 1 and 2), since the numbers of the forward flow paths 422, the first backward flow paths 22 and the second backward flow paths 423 of this embodiment are increased, the flow rate of the air flowing in the pneumatic device for driving the reciprocating movement of the piston rod 3 is increased, so that the mechanical strength of the sawing operation of the pneumatic saw is superior.

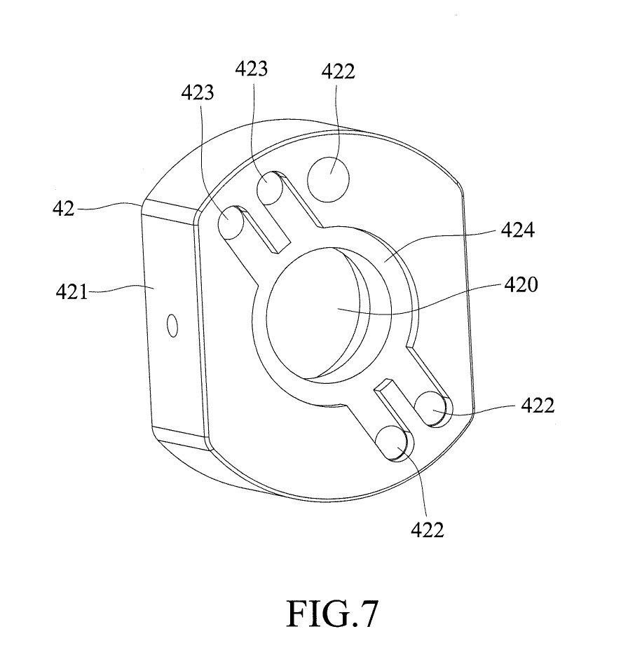

Referring to FIG. 7, the main valve seat 42 of the second embodiment of the pneumatic device according to the disclosure is similar to that of the first embodiment.

In the second embodiment, the main valve seat 42 includes only one forward flow path 422. The total cross-sectional area of the second backward flow paths 423 is 2 to 6 percent of the cross-sectional area of the main valve seat 42. Note that the rear valve seat 43 (with reference to FIGS. 5 and 6) of this second embodiment may have only one of the secondary flow path 4312 that is in fluid communication with the intake passage 431 and the forward flow paths 422.

By such, the flow rate of the air flowing in the pneumatic device for moving the piston rod 3 toward the restoring position is increased, so that the mechanical strength of the sawing operation of the pneumatic saw is superior.

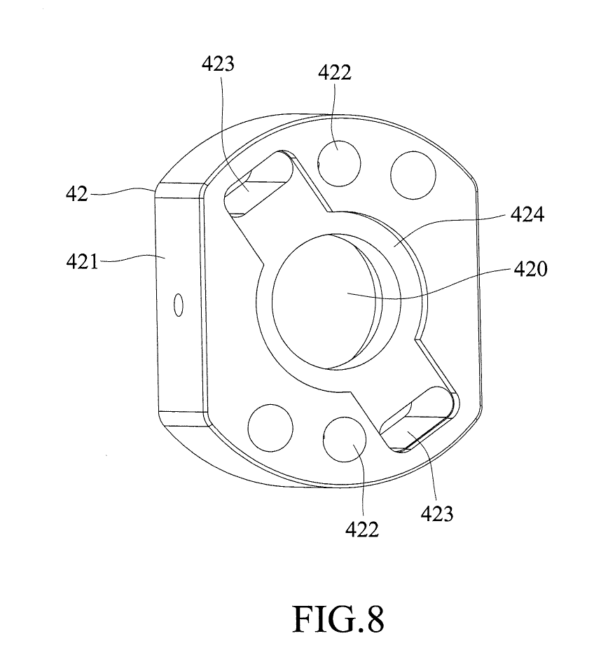

Referring to FIG. 8, the main valve seat 42 of the third embodiment of the pneumatic device according to the disclosure is similar to that of the first embodiment.

In the third embodiment, each of the second backward flow path units of the main valve seat 42 includes only one second backward flow path 423 that is configured as an oblong through hole and that is in fluid communication with a respective one of the intermediate hole units of the front valve seat 41 (see FIG. 3). The total cross-sectional area of the second backward flow paths 423 is 2 to 6 percent of the cross-sectional area of the main valve seat 42. It should be noted that, in this embodiment, each of the intermediate hole units of the front valve seat 41 may include only one intermediate hole 412, and the cylinder 2 may include two of the first backward flow paths 22.

By such, the flow rate of the air flowing in the pneumatic device for moving the piston rod 3 between the impact position the restoring position is increased, so that the strength of the sawing operation of the pneumatic saw is superior.

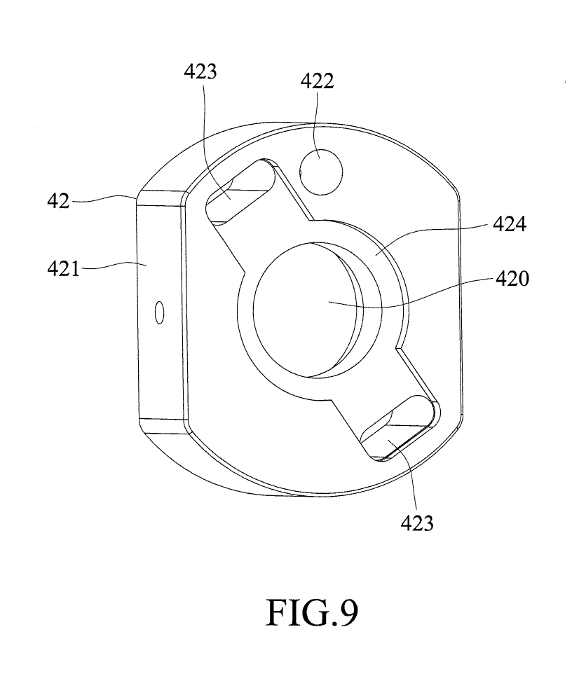

FIG. 9 illustrates the main valve seat 42 of the fourth embodiment of the pneumatic device according to the disclosure.

In the fourth embodiment, the main valve seat 42 of the second embodiment includes only one forward flow path 422, and each of the second backward flow path units of the main valve seat 42 includes only one second backward flow paths 423 that is configured as an oblong through hole and that is in fluid communication with a respective one of the intermediate hole units of the front valve seat 41 (see FIG. 3). The total cross-sectional area of the second backward flow paths 423 is 2 to 6 percent of the cross-sectional area of the main valve seat 42. Note that the rear valve seat 43 (with reference to FIGS. 5 and 6) of this second embodiment may have only one of the secondary flow path 4312 that is in fluid communication with the intake passage 431 and the forward flow paths 422.

By such, the flow rate of the air flowing in the pneumatic device for moving the piston rod 3 toward the restoring position is increased, so that the mechanical strength of the sawing operation of the pneumatic saw is superior.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

1. A pneumatic device comprising:
a cylinder including a cylinder wall that defines an air chamber therein, and a plurality of first backward flow paths that are formed in said cylinder wall, each of said first backward flow paths extending from a first end of said cylinder wall toward a second end of said cylinder wall that is opposite to said first end, and being in fluid communication with a portion of said air chamber that is adjacent to said second end of said cylinder wall;
a piston rod movably mounted to said cylinder, and operable to move relative to said cylinder between an impact position and a restoring position; and
a valve unit connected to said first end of said cylinder wall of said cylinder, and including a valve seat assembly that defines a valve space therein, and a valve member that is movably disposed in said valve space, said valve seat assembly including an intake passage that is adapted for guiding inflow of air, a communicating hole that is in fluid communication with another portion of said air chamber adjacent to said first end of said cylinder wall, a plurality of forward flow paths that are in fluid communication with said intake passage and said valve space, and a plurality of second backward flow paths that are respectively in fluid communication with said first backward flow paths, said valve member being operable to move relative to said valve seat assembly between a first position where fluid communication between said intake passage and each of said second backward flow paths is prevented, and a second position where fluid communication between each of said forward flow paths and said communicating hole is prevented;
wherein, when said valve member is at the first position, air flows from said intake passage, through said forward flow paths, said valve space and said communicating hole and into said air chamber, so that said piston rod is moved toward the impact position; and
wherein, when said valve member is at the second position, air flows from said intake passage, through said second backward flow paths and said first backward flow paths and into said air chamber, so that said piston rod is moved toward the restoring position.

2. The pneumatic device as claimed in claim 1, wherein said valve seat assembly includes two of said forward flow paths.

3. The pneumatic device as claimed in claim 1, wherein said forward flow paths of said valve seat assembly are located at two diametrically-opposite sides of said valve space.

4. The pneumatic device as claimed in claim 3, wherein said second backward flow paths of said valve seat assembly are located at another two diametrically-opposite sides of said valve space, each of said second backward flow paths being proximate to one of said forward flow paths.

5. The pneumatic device as claimed in claim 1, wherein said valve seat assembly includes a front valve seat that is formed with said communicating hole, a main valve seat that is formed with said valve space, said forward flow paths and said second backward flow paths, and a rear valve seat that is formed with said intake passage, said front valve seat being further formed with a plurality of intermediate holes each of which is in fluid communication with a respective one of said second backward flow paths and a corresponding one of said first backward flow paths.

6. The pneumatic device as claimed in claim 5, wherein said cylinder includes two of said first backward flow paths, said front valve seat including two of said intermediate holes, said main valve seat including two of said second backward flow paths.

7. The pneumatic device as claimed in claim 6, wherein each of said first backward flow paths, said intermediate holes and said second backward flow paths is configured as an oblong hole.

8. The pneumatic device as claimed in claim 5, wherein said cylinder includes four of said first backward flow paths, said front valve seat including four of said intermediate holes, said main valve seat including four of said second backward flow paths.

9. The pneumatic device as claimed in claim 6, wherein said main valve seat further includes a communicating groove that is formed at an end thereof distal from said cylinder and that is in fluid communication with said valve space and said second backward flow paths.

10. The pneumatic device as claimed in claim 5, wherein said rear valve seat further has a primary flow path that is in fluid communication with said intake passage, and a plurality of secondary flow paths each of which is in fluid communication with said intake passage and a respective one of said forward flow paths.

11. A pneumatic device comprising:
a cylinder including a cylinder wall that defines an air chamber therein, and a plurality of first backward flow paths that are formed in said cylinder wall, each of said first backward flow paths extending from a first end of said cylinder wall toward a second end of said cylinder wall that is opposite to said first end, and being in fluid communication with a portion of said air chamber that is adjacent to said second end of said cylinder wall;
a piston rod movably mounted to said cylinder, and operable to move relative to said cylinder between an impact position and a restoring position; and
a valve unit connected to said first end of said cylinder wall of said cylinder, and including a valve seat assembly that defines a valve space therein, and a valve member that is movably disposed in said valve space, said valve seat assembly including an intake passage that is adapted for guiding inflow of air, a communicating hole that is in fluid communication with another portion of said air chamber adjacent to said first end of said cylinder wall, a forward flow path that is in fluid communication with said intake passage and said valve space, and a plurality of second backward flow paths that are respectively in fluid communication with said first backward flow paths, the total cross-sectional area of said second backward flow paths being 2 to 6 percent of the cross-sectional area of said valve seat assembly, said valve member being operable to move relative to said valve seat assembly between a first position where fluid communication between said intake passage and each of said second backward flow paths is prevented, and a second position where fluid communication between each of said forward flow paths and said communicating hole is prevented;
wherein, when said valve member is at the first position, air flows from said intake passage, through said forward flow paths, said valve space and said communicating hole and into said air chamber, so that said piston rod is moved toward the impact position; and
wherein, when said valve member is at the second position, air flows from said intake passage, through said second backward flow paths and said first backward flow paths and into said air chamber, so that said piston rod is moved toward the restoring position.

12. The pneumatic device as claimed in claim 11, wherein said second backward flow paths of said valve seat assembly are located at two diametrically-opposite sides of said valve space.

13. The pneumatic device as claimed in claim 11, wherein said valve seat assembly includes a front valve seat that is formed with said communicating hole, a main valve seat that is formed with said valve space, said forward flow path and said second backward flow paths, and a rear valve seat that is formed with said intake passage, said front valve seat being further formed with a plurality of intermediate holes each of which is in fluid communication with a respective one of said second backward flow paths and a corresponding one of said first backward flow paths.

14. The pneumatic device as claimed in claim 13, wherein said cylinder includes two of said first backward flow paths, said front valve seat including two of said intermediate holes, said main valve seat including two of said second backward flow paths.

15. The pneumatic device as claimed in claim 14, wherein each of said first backward flow paths, said intermediate holes and said second backward flow paths is configured as an oblong hole.

16. The pneumatic device as claimed in claim 13, wherein said cylinder includes four of said first backward flow paths, said front valve seat including four of said intermediate holes, said main valve seat including four of said second backward flow paths.

17. The pneumatic device as claimed in claim 14, wherein said main valve seat further includes a communicating groove that is formed at an end thereof distal from said cylinder and that is in fluid communication with said valve space and said second backward flow paths.

18. The pneumatic device as claimed in claim 13, wherein said rear valve seat further has a primary flow path that is in fluid communication with said intake passage, and a of secondary flow paths that is in fluid communication with said intake passage and said forward flow path.

19. The pneumatic device as claimed in claim 8, wherein said main valve seat further includes a communicating groove that is formed at an end thereof distal from said cylinder and that is in fluid communication with said valve space and said second backward flow paths.
